(19) United States
(12) Patent Application Publication
(10) Pub. No.: US 2024/0125085 A1
(43) Pub. Date: Apr. 18, 2024

(54) ATTACHMENT WITH GROUND SUPPORT MEMBER

(71) Applicant: LAVALLEY INDUSTRIES, LLC, Bemidji, MN (US)

(72) Inventor: Jason LaValley, Bemidji, MN (US)

(21) Appl. No.: 18/547,380

(22) PCT Filed: Feb. 18, 2022
(86) PCT No.: PCT/US2022/017050

§ 371 Date: Aug. 22, 2023

Related U.S. Application Data
(60) Provisional application No. 63/151,868, filed on Feb. 22, 2021.

(51) Int. Cl. E02F 3/96; F16L 1/06

(52) U.S. Cl. CPC E02F 3/962; E02F 3/968; F16L 1/065

(57) ABSTRACT

An attachment that is mountable to an arm of construction equipment includes a mount bracket that is removably attachable to the arm of the construction equipment. An implement is mounted to the mount bracket, where the implement is configured to perform at least one jobsite task. At least one ground support member is mounted on the attachment, and the at least one ground support member includes at least two support legs that are actuatable between a retracted position and an extended, ground-engaging position at which the at least one ground support member is able to support the attachment on the ground when the mount bracket is not attached to the arm of the construction equipment.

### FIELD

This technical disclosure relates to an attachment that is attachable to construction equipment and that is configured to perform a jobsite task using an implement mounted on the attachment. The attachment may be supported on the ground using at least one ground support member on the attachment.

### BACKGROUND

An attachment that attaches to the arm of construction equipment, such as an excavator, and that performs a jobsite task that includes grabbing two sections of pipe, aligns the ends of the two pipes, and processes the ends of the two pipes is known. Examples of such attachments are disclosed in U.S. Pat. Nos. 8,328,071; 8,590,769; 8,973,244; 9,452,497; 10,226,842; 10,344,892; 10,661,397; and 10,844,977.

### SUMMARY

An attachment is described that is attachable to an arm of construction equipment, such as an excavator. The attachment includes at least one ground support member that is configured to directly support the attachment on the ground, separate from the indirect ground support that occurs from the arm and the construction equipment being on the ground. The ground support member may simply support the attachment on the ground, for example when the attachment is not in use performing a jobsite task. In another embodiment, the ground support member may support the attachment on the ground while the attachment is performing a jobsite task.

The attachment may remain attached to the arm of the construction equipment when the ground support member thereof is engaged with the ground, or the attachment may be disconnected from the construction equipment once the ground support member is engaged with the ground and supporting the attachment.

In one embodiment, the attachment can include an implement that is configured to perform at least one jobsite task. The implement may be configured as a grapple attachment that is configured to perform a jobsite task that includes simultaneously grabbing two adjacent objects, for example two sections of pipe, aligning the ends of the two pipes, and performing a processing operation on one or more of the ends of the two pipes. However, other implement designs and implement functions are possible. When configured as a grapple attachment, the attachment can be used to simultaneously grab any two objects that may need to be positioned relative to one another and perhaps processed. The objects can be pipes, poles, logs, and other objects. In another embodiment, the grapple attachment can hold a single object including, but not limited to, a large drill attachment or an object during maintenance on the object.

In this embodiment where the attachment is configured as a grapple attachment that grabs two pipes, directly supporting the grapple attachment on the ground using the ground support member(s) prevents slight movements of the grapple attachment during the processing operation that can occur in conventional grapple attachments of this type due to slight movements of the construction equipment arm. Slight movements of the construction equipment arm can result from a number of causes including, but not limited to, fluid leakage that occurs in hydraulic cylinders on the construction equipment that hold the arm in position, or the construction equipment slightly sinking into the ground due to its weight. So the ground support(s) described herein allow the processing operation(s) on the pipes to be performed without being impacted by, or minimize the impact of, hydraulic leakage of the construction equipment or settling of the construction equipment. In one embodiment, the processing operation(s) that is performed can include welding the pipe ends together. Stability and lack of movement of the grapple attachment is important during welding of the two pipes to ensure an adequate weld is achieved. However, other pipe processing operations can be performed.

The ground support member(s) can have any configuration that is suitable to stably support the attachment on the ground separate from the indirect support that occurs via the arm and the construction equipment. For example, the ground support member(s) may be a first ground support member and a second ground support member mounted on the attachment. The first ground support member and the second ground support member can each include a pair of support legs that are actuatable between a retracted position and an extended, ground-engaging position.

The language “engaged with the ground”, as in the legs of the ground support member are engaged with the ground, or similar includes direct physical engagement between the support legs and the ground, as well as includes an intervening support element such as a plate, a block and the like disposed between the ends of the support legs and the ground. In addition, “engaged with the ground” includes engagement that occurs with the ground “on grade”, “below grade” (e.g. for example in a trench where the ground support member(s) is engaged with side walls of the trench), or “above grade”.

In one embodiment described herein, an attachment that is mountable to an arm of construction equipment is described. The attachment can include a mount bracket that is removably attachable to the arm of the construction equipment. At least one ground support member is mounted on the attachment, where the at least one ground support member includes a pair of support legs, and the support legs are actuatable between a retracted position and an extended, ground-engaging position at which the at least one ground support member supports the attachment on the ground.

In another embodiment described herein, a grapple attachment can include a main beam, a first grapple mechanism and a second grapple mechanism mounted on the main beam, where the first grapple mechanism and the second grapple mechanism each includes opposing grab arms, and a pipe processing tool, such as but not limited to a welding tool, is positioned between the first grapple mechanism and the second grapple mechanism. One or more of the ground support members can be mounted on the grapple attachment that can be used to support the grapple attachment on the ground.

In another embodiment, a method described herein can include mounting an attachment to an arm of construction equipment. Thereafter, with the attachment attached to the arm, support legs on the attachment are actuated to an extended, ground engaging position in engagement with the ground so that the attachment is supported by the ground.

In another embodiment described herein, a method of processing pipe can include mounting a grapple attachment to an arm of construction equipment. The grapple attachment is configured to be able to grab an end of a first pipe and grab an end of a second pipe, align the first pipe and the second pipe, and bring the end of the first pipe and the end of the second pipe adjacent to one another. With the grapple attachment attached to the arm, one or more of the ground support members are actuated to support the grapple attachment on the ground. For example, support legs of the ground support members can be actuated to an extended, ground engaging position in engagement with the ground so that the grapple attachment is supported by the ground. Once the grapple attachment is supported on the ground by the ground support member(s), processing occurs on one or more of the pipes. For example, in one embodiment, the end of the first pipe can be welded to the end of the second pipe using a welding tool mounted on the grapple attachment. During pipe processing, the grapple attachment may remain attached to the arm or the grapple attachment may be detached from the arm.

### DRAWINGS

FIG. 1 illustrates a known attachment mounted on construction equipment.

FIG. 2A is a close-up perspective view of the attachment of FIG. 1 with the processing tool thereof in a closed configuration.

FIG. 2B is a view similar to FIG. 2A, but with the processing tool in an open configuration

FIG. 3 is a side view of the attachment of FIG. 1.

FIG. 4 is a detailed perspective view of the processing tool of the attachment of FIG. 1.

FIG. 5 is an end view of one deformation ring of the processing tool of FIG. 4.

FIG. 6 depicts an attachment with one or more ground support members described herein.

FIG. 7 is an end view of the attachment of FIG. 6.

FIG. 8 illustrates another embodiment of a ground support member on an attachment, with support legs of the ground support member in a retracted position.

FIG. 9 is a view similar to FIG. 8 but with the support legs in an extended, ground-engaging position.

FIG. 10 illustrates another embodiment with a ground support member similar to FIGS. 8 and 9 supporting an attachment with no task performing implements mounted on the attachment.

### DETAILED DESCRIPTION

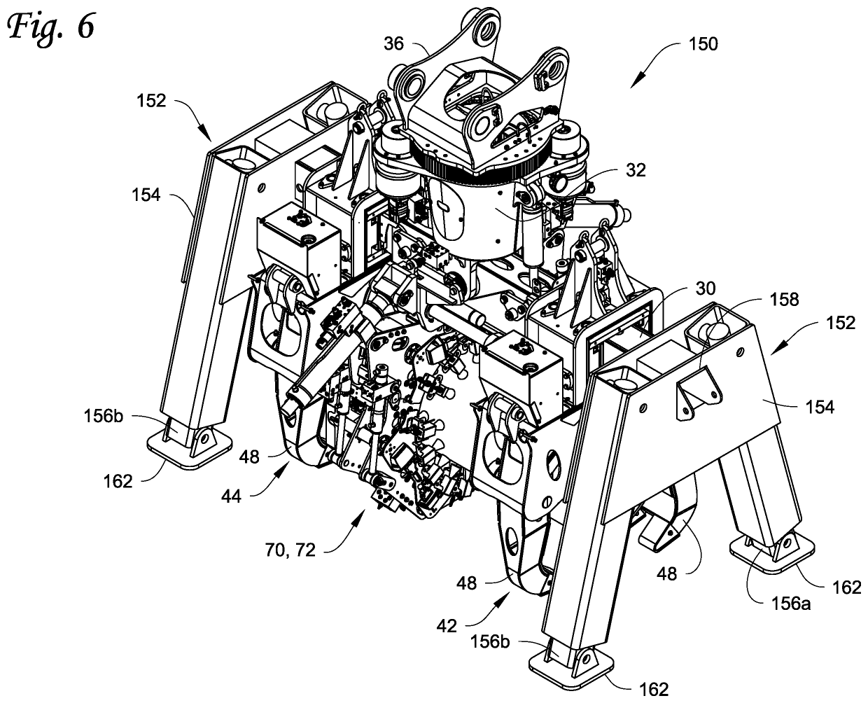

Attachments are described below with respect to FIGS. 6-10 that are attachable to an arm of construction equipment, such as an excavator, and that include at least one ground support member that is configured to directly support the attachment on the ground, separate from the indirect ground support of the attachment that occurs from the arm and the construction equipment being on the ground. The ground support members may simply support the attachments on the ground, for example when the attachment is not in use performing a jobsite task. In another embodiment, the ground support member may support the attachment on the ground while the attachment is performing the jobsite task.

The attachments in FIGS. 6-10 are configured to perform at least one jobsite task using an implement that is mounted on the attachment. In one embodiment, the implement may be configured to perform a jobsite task that includes grabbing two sections of pipe, aligning the ends of the two pipes, and processing one or more of the ends of the two pipes. In such an embodiment, the attachment may also be referred to as a grapple attachment. The processing performed by the implement may be one or more of welding, coating, cutting, sealing, beveling or sand blasting the ends of the pipes. However, the concepts described herein with respect to FIGS. 6-10 are not limited to the attachments being grapple attachments and are not limited to use with pipes or processing pipes. The attachment can be used with any objects that may need to be positioned relative to one another and perhaps processed. The objects can be pipes, poles, logs, and other objects. In the case of pipes, the pipes can be made of metal, plastic and other materials.

The language “engaged with the ground”, as in the support legs of the ground support member are engaged with the ground, or similar, includes direct physical engagement between the support legs of the ground support member and the ground, as well as includes an intervening support element such as a plate, a block and the like being disposed between the end of the support legs and the ground. In addition, “engaged with the ground” includes engagement that occurs with the ground “on grade”, “below grade” (e.g. for example in a trench where the ground support member(s) is engaged with side walls of the trench), or “above grade”.

The term “attachment” includes all kinds of attachments, including but not limited to a grapple attachment, where the attachment is attachable to an arm of construction equipment, such as an excavator, and that is configured to perform at least one jobsite task using an implement that is mounted on the attachment. The term “grapple attachment” refers to a specific kind of attachment that is configured to perform a jobsite task that involves grabbing or grasping one or more objects. However, other attachment designs having other types of implements performing other jobsite functions are possible.

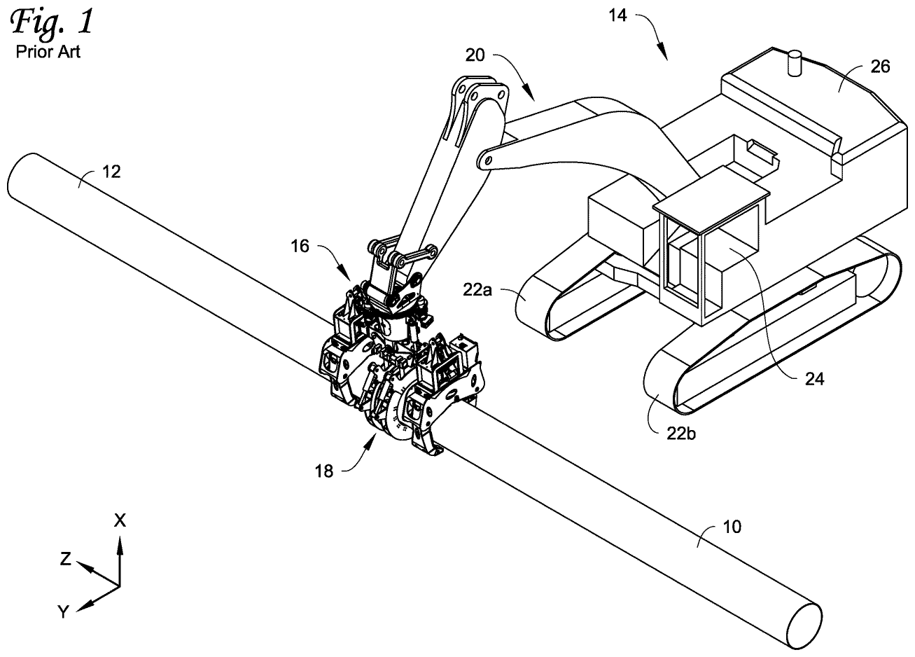

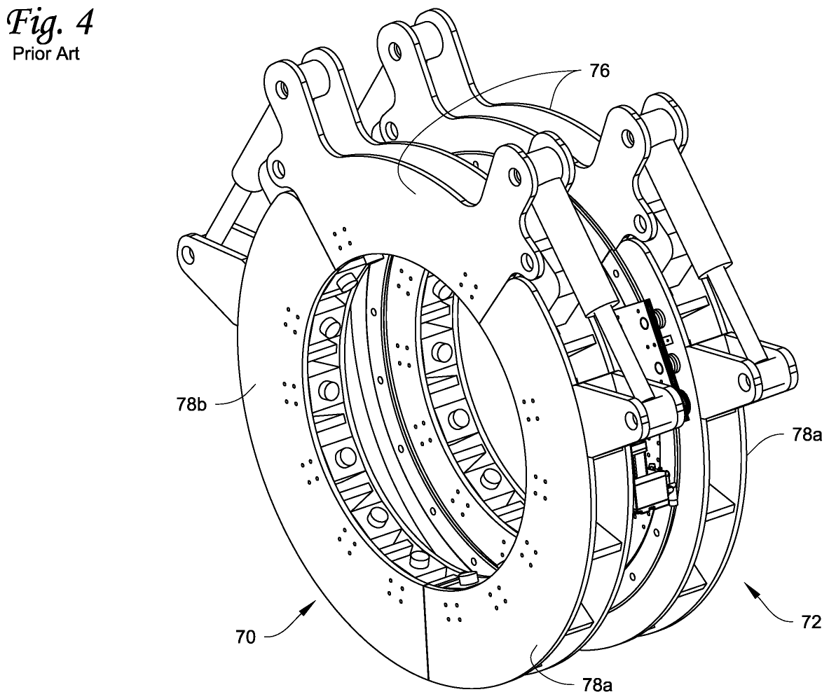

To help explain the inventive concepts of FIGS. 6-10, a known attachment in the form of a grapple attachment will be described with respect to FIGS. 1-5. The grapple attachment in FIGS. 1-5 is configured to grab two sections of pipe, align the ends of the two pipes, and process one or more of the ends of the two pipes, for example by welding the ends to one another. Further details on the grapple attachment in FIGS. 1-5 are disclosed in U.S. Pat. Nos. 8,328,071; 8,590,769; 8,973,244; 9,452,497; 10,226,842; 10,344,892; 10,661,397; and 10,844,977, each of which is incorporated herein by reference in its entirety.

FIG. 1 illustrates a known attachment in the form of a grapple attachment 16. The grapple attachment 16 is mounted to construction equipment 14, such as an excavator or any other type of construction equipment to which the grapple attachment 16 can be mounted for performing pipe laying and implementing an attachment process where an end of a first pipe 10 is aligned with an end of a second pipe 12 and the ends are then processed, for example by welding the ends to one another. The construction equipment 14 is illustrated in FIG. 1 as being an excavator that includes a hydraulically controllable arm 20, left and right tracks 22a, 22b, an operator's cab 24 and an engine assembly 26. The excavator is of generally well known construction and as would be understood by a person of ordinary skill in the art, the tracks 22a, 22b are used to steer the excavator and move the excavator from position to position. In addition, the upper portion of the excavator including the cab 24 and the engine assembly 26 are rotatable about a vertical axis relative to the tracks 22a, 22b. However, the construction equipment is not limited to being an excavator and other types of construction equipment can be used.

The grapple attachment 16 is mounted to an arm 20 of the construction equipment 14. With reference to FIGS. 1-3, the grapple attachment 16 includes a main beam 30 that is pivotally connected to the base of a lower head assembly 32 by a pivot 34 for pivoting about a y-axis. The lower head assembly 32 is rotatably connected to a mount bracket 36 to permit the lower head assembly 32 to rotate or swivel 360 degrees relative to the mount bracket about a vertical x-axis. The mount bracket 36 detachably mounts the grapple attachment 16 to the arm 20 of the construction equipment. One or more tilt actuators 38, 40 extend between the lower head assembly 32 and the main beam 30 to selectively tilt the main beam about the pivot 34 (i.e. about the y-axis). Further information on the construction and operation of a main beam, lower head assembly, mount bracket and the tilt actuators can be found in U.S. Pat. Nos. 8,146,971 and 8,567,836, which are incorporated herein by reference in their entireties.

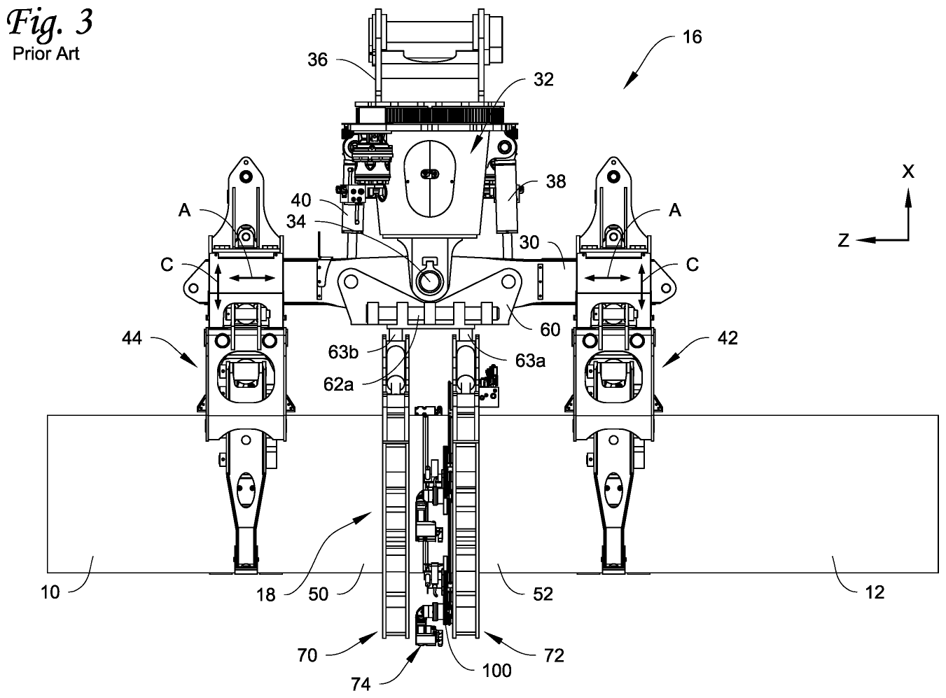

The grapple attachment 16 includes a pair of grapple mechanisms 42, 44 mounted on the main beam 30. With reference to FIG. 3, the grapple mechanisms 42, 44 are mounted on the main beam so that each grapple mechanism is individually adjustable relative to the main beam 30 along the length of the main beam in a z-axis direction as shown by the arrows A in FIG. 3. Adjustment of each grapple mechanism 42, 44 is achieved by shift cylinders (not visible) which are disposed within the main beam, and each of which is fixed at one end to the main beam and fixed at an opposite end to the grapple mechanisms 42, 44. If desired, the shift cylinders can be located outside of the main beam. Further information on shifting grapple mechanisms on a main beam in a z-axis direction is described in U.S. Pat. No. 8,567,836 the entire contents of which are incorporated herein by reference.

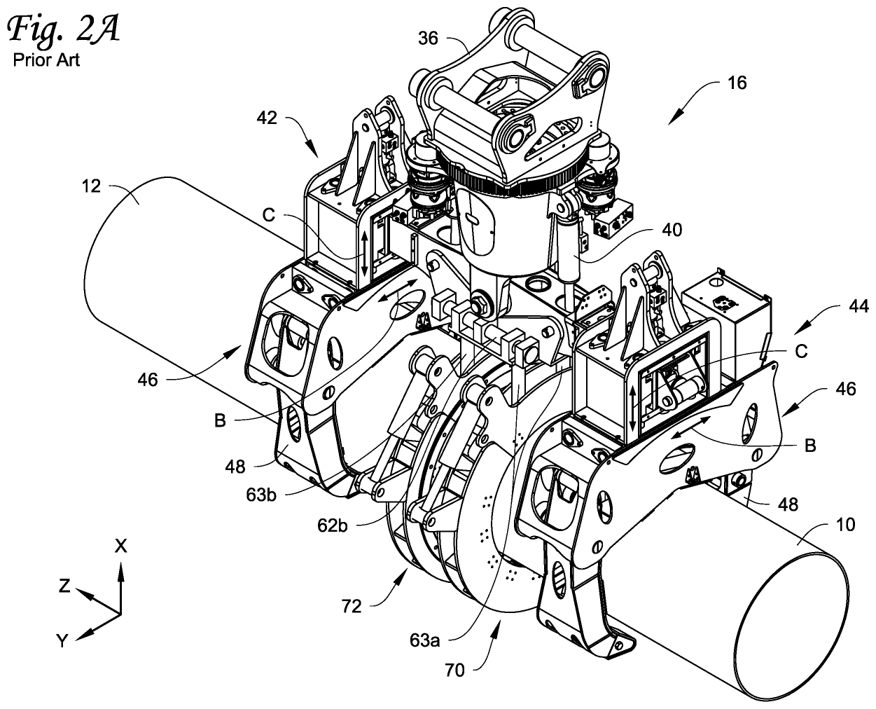

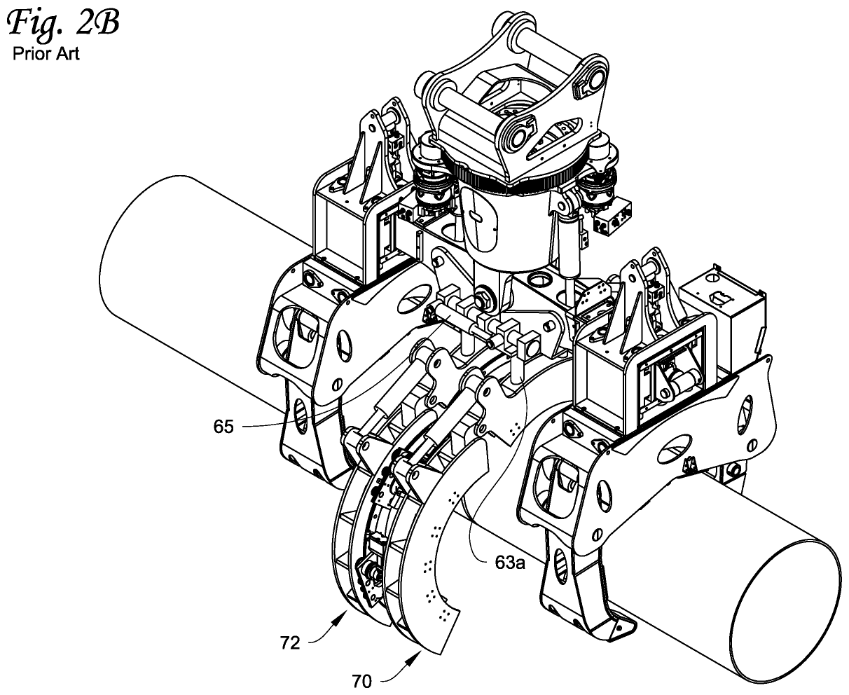

In addition, the grapple mechanisms 42, 44 are shiftable forward and backward in the y-axis direction shown by the arrows B in FIG. 2A, and up and down in the x-axis direction as shown by the arrows C in FIG. 3, to shift the positions of the pipe ends in the y-axis and x-axis directions. Further information on shifting grapple mechanisms in y-axis and x-axis directions is disclosed in U.S. Pat. No. 9,073,732 the entire contents of which are incorporated herein by reference.

The grapple mechanism 42, 44 can be identical in construction, but can also be different in construction from each other. Each grapple mechanism includes a grab arm housing 46 and grab arms 48 connected to the grab arm housing. Operation of the grab arms 48 is controlled using one or more hydraulic cylinders on the grapple mechanisms 42, 44. In one embodiment, the grab arm housings are similar in construction and operation to the grab arm housings described in U.S. Pat. No. 9,073,732.

As shown in FIGS. 1-3, each grapple mechanism 42, 44 is designed to pick up a respective end 50, 52 of the pipes 10, 12 using the grab arms 48 under the power of the construction equipment 14. The positions of the grab arm housings 46 can then be adjusted in the x, y and/or z-axis directions as necessary to align the pipe ends 50, 52 during pipe attachment. In addition, the lower head assembly 32 can be rotated about the x-axis, the main beam 30 can be pivoted about the pivot 34 (i.e. about the y-axis), the arm 20 of the excavator can be adjusted, and the position of the excavator can be adjusted, in order to help achieve alignment of the pipe ends 50, 52. Any combinations of these adjustments can be utilized in order to achieve alignment of the pipe ends.

Once the pipe ends are aligned, the ends can then be welded or otherwise secured to each other, for example using a pipe processing system 18 on the grapple attachment 16. Prior to welding or after welding, other pipe processing operations can be performed on the pipe ends 50, 52 using the pipe processing system 18.

The pipe processing system 18 is configured to clamp onto at least one of the pipe ends 50, 52 and help hold the alignment between the pipe ends. The pipe processing system 18 is also configured to perform one or more processing operations on the ends 50, 52 of the pipes. Examples of processing operations include, but are not limited to, welding the pipe ends 50, 52 together, coating one or more of the pipe ends, painting the pipe ends, cutting one or more of the pipe ends, applying a seal to seal the pipe ends, beveling one or more of the pipe ends, or sand blasting one or more of the pipe ends. Other processing operations are possible. Depending upon the processing operation, the processing operation can be performed before or after the pipe ends are aligned with each other.

In the illustrated embodiment, the pipe processing system 18 is mounted on the grapple attachment 16 between the grapple mechanisms 42, 44. The system 18 is mounted to permit side-to-side shifting and up and down shifting of the system 18 which permits the position of the system 18 to be precisely adjusted relative to the pipe ends 50, 52.

With reference to FIGS. 2A, 2B and 3, the pipe processing system 18 is mounted on a bracket 60 that is attached to the main beam 30. The bracket includes first and second support rods 62a, 62b on opposite sides of the main beam 30. The support rods 62, 62b permit side to side adjustment of the position of the pipe processing system 18 in the z-axis direction. Adjustment of the pipe processing system 18 in the z-axis direction can be performed using one or more actuators 65 (visible in FIG. 2B). FIG. 3 shows the pipe processing system 18 in a centered position on the rods 62a, 62b.

FIGS. 2A, 2B, and 3 also illustrate actuators 63a, 63b that are fixed at one end to the bracket 60 and at their opposite ends to the system 18 for adjusting the system 18 vertically up and down in the x-axis direction. In the illustrated example, there are two of the actuators 63a and two of the actuators 63b. However, a single one of each of the actuators 63a, 63b could be used. FIG. 3 shows the pipe processing system 18 in a vertically center position. FIG. 2A shows the system 18 shifted vertically downward for engagement with the pipe ends.

As shown in FIGS. 2A, 2B and 3, the pipe processing system 18 includes first and second conforming rings 70, 72 that are configured to clamp onto the pipes 10, 12 adjacent to the ends 50, 52 thereof on either side of the joint between the ends. The construction of each of the conforming rings 70, 72 are substantially similar to one another, except that either or both of the conforming rings includes at least one pipe processing mechanism 74 (discussed further below) mounted thereon for performing a particular processing operation. Therefore, only one of the conforming rings 70, 72 will be described in detail, it being understood that the other conforming ring can be substantially identical in construction with or without the pipe processing mechanism 74. In one embodiment, each of the conforming rings includes at least one pipe processing mechanism. In another embodiment, the pipe processing mechanism(s) on the conforming ring 70 can be configured to perform the same or similar processing operation as the pipe processing mechanism(s) on the conforming ring 72, or the pipe processing mechanism(s) on the conforming ring 70 can be configured to perform a different processing operation than the pipe processing mechanism(s) on the conforming ring 72.

Further details on the system 18, the conforming rings 70, 72, and pipe processing mechanisms including a welder can be found in U.S. Pat. Nos. 8,973,244; 10,344,892; and 10,844,977 each of which is incorporated herein by reference in its entirety.

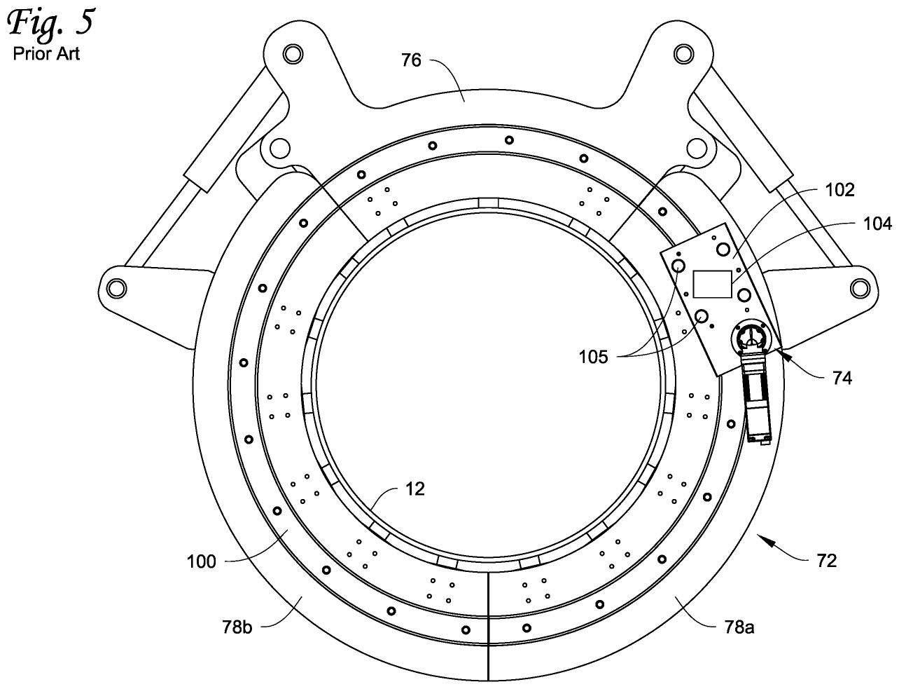

At least one of the conforming rings 70, 72, for example the conforming ring 72, includes a 360 degree track 100 disposed thereon as best illustrated in FIGS. 3 and 5. The track 100 can be disposed on either side of a central support member 76 and clamshell members 78a, 78b, but in the illustrated example is mounted on the side facing the other conforming ring. In the illustrated example, the track 100 comprises a raised bar that is spaced from the side surface of the conforming ring on which it is disposed, and which is configured to movably support the pipe processing mechanism 74 in a manner to permit the pipe processing mechanism 74 to move 360 degrees along the track 100.

The pipe processing mechanism 74 can be any structure(s) that can move along the track 100 and which can be configured to perform at least one processing operation on one or both ends 50, 52 of the pipes 10, 12. As seen in FIG. 5, the pipe processing mechanism 74 can include a carrier 102 that is provided with a plurality of mounting holes 105 that permits removable mounting of various sensors and pipe processing tools 104 to the carrier 102. The pipe processing tool(s) 104 mounted to the carrier 102 determines the processing operation that is performed. The pipe processing tool(s) 104 can be configured to perform processing operations that can include, but are not limited to, welding, coating, cutting, sealing, beveling or sand blasting. In an embodiment, the pipe processing tool(s) 104 can be a facing machine or other pipe processing machine, or a facing machine or other pipe processing machine can be provided on the attachment separate from the pipe processing tool(s) 104. In the illustrated example, the pipe processing tool 104 can be configured to perform welding and includes a welder mounted on the carrier 102 for welding the ends 50, 54 of the pipes 10, 12 to one another. An example of a pipe processing tool in the form of a welder on a pipe processing mechanism can be found in U.S. Pat. Nos. 8,973,244; 10,344,892; and 10,844,977 each of which is incorporated herein by reference in its entirety.

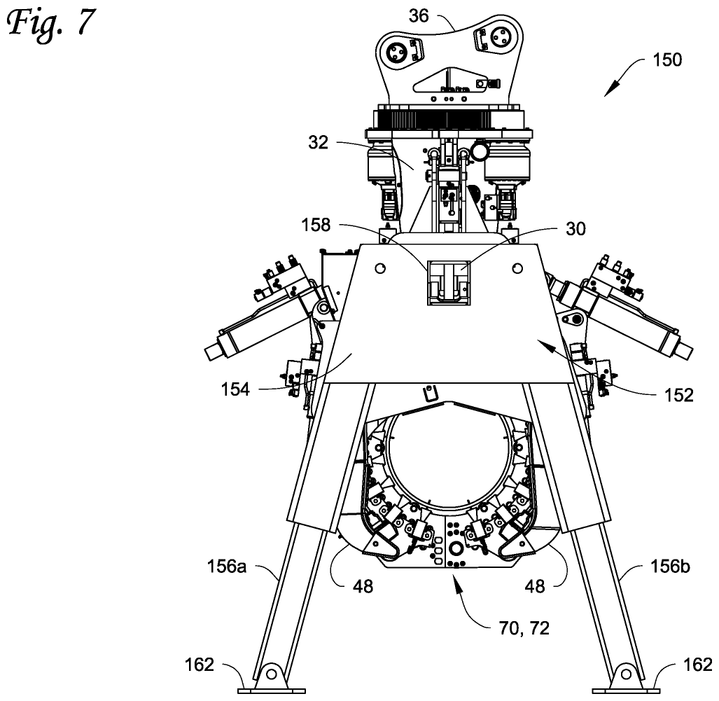

Turning now to FIGS. 6 and 7, an example of an attachment 150 is illustrated having one or more ground support members 152 that are configured to directly support the attachment 150 on the ground. The grapple attachment 150 is illustrated in FIGS. 6 and 7 as including two of the ground support members 152. However, a single ground support member 152 or more than two ground support members 152 can be used. The ground support members 152 may also be referred to as ground stabilization mechanisms.

The attachment 150 can have a general construction that is similar to the grapple attachment 16 in FIGS. 1-5 except for the ground support member(s) 152. Accordingly, the attachment 150 may also be referred to as a grapple attachment. In FIGS. 6 and 7, elements that are similar to elements in FIGS. 1-5 are referenced using the same reference numerals. However, the attachment 150 is not limited to being a grapple attachment.

The attachment 150 is illustrated in FIGS. 6 and 7 as including the main beam 30, the first grapple mechanism 42 and the second grapple mechanism 44 mounted on the main beam 30, where the first grapple mechanism 42 and the second grapple mechanism 44 each includes opposing grab arms 48, and the system with the conforming rings 70, 72 (also referred to as a pipe conforming mechanism). Similar to the description above for the grapple attachment 16, a welding tool or other pipe processing tool, which can be similar to the tool 104, is mounted on one or more of the conforming rings 70, 72 for welding the pipes or performing another pipe processing operation on one or more of the pipes while the attachment 150 is holding the pipes.

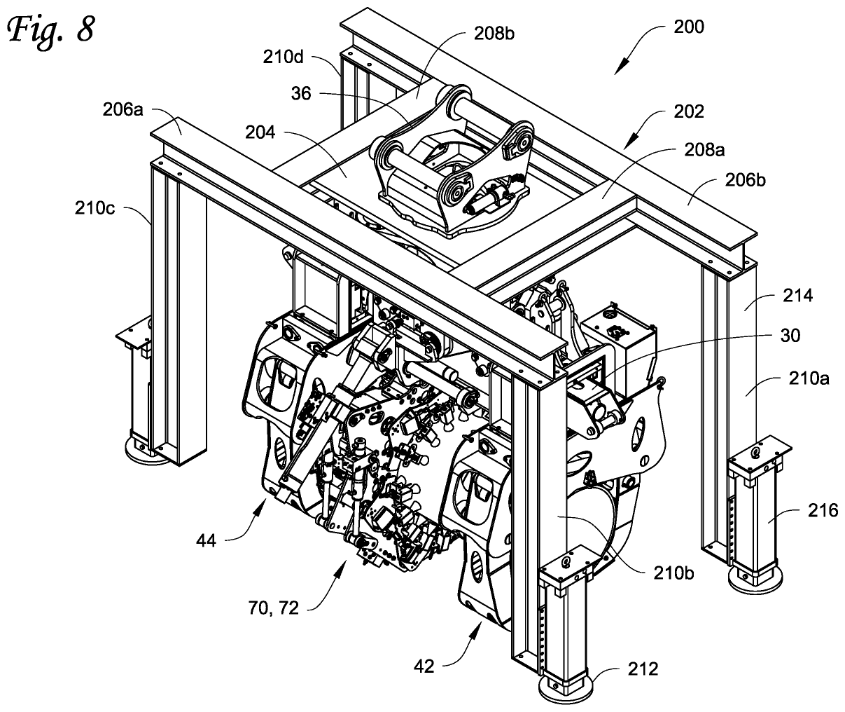

FIGS. 6 and 7 illustrate the ground support members 152 as being mounted on the main beam 30. However, the ground support members 152 may be mounted to other structures on the attachment 150, for example as depicted in FIGS. 8-10. In addition, the first grapple mechanism 42, the second grapple mechanism 44, and the deformation rings 70, 72 are positioned between the ground support members 152, with the ground support members 152 disposed at opposite ends of the main beam 30.

Each of the ground support members 152 includes a housing 154 and a pair of support/stabilization legs 156a, 156b. Each housing 154 includes a passageway 158 that receives the main beam 30. In one embodiment, the passageway 158 may extend completely through the housing 154 with the main beam 30 extending completely through the housing 154.

The support legs 156a, 156b are attached to and extend from the housing 154. Each one of the support legs 156a, 156b is individually actuatable between a retracted position shown in FIG. 6 and an extended, ground-engaging position shown in FIG. 7. The legs 156a, 156b may be actuated by suitable actuators including, but not limited to, hydraulic, pneumatic or electric actuators. In one embodiment, the support legs 156a, 156b may also be manually actuated between the retracted and extended positions. The end of each support leg 156a, 156b can also include a ground engagement pad 162 each of which is pivotally attached to the end of the respective support leg 156a, 156b.

In general operation of the attachment 150, the attachment 150 is mounted to the arm 20 of the construction equipment 14 (see FIG. 1), where the attachment 150 includes an implement that is configured to perform at least one jobsite task. In the example in FIGS. 6 and 7, the implement can be the beam 30, the grapple mechanisms 42, 44, and the pipe processing system 18, and the jobsite task includes grabbing the ends of the pipes, aligning the ends of the pipes, and processing one or more of the ends of the two pipes, for example welding the ends of the pipes to one another. The at least one jobsite task is performed using the implement, and thereafter, with the attachment 150 attached to the arm, the support legs 156a, 156b on the attachment 150 are actuated to an extended, ground engaging position in engagement with the ground so that the attachment 150 is supported by the ground.

The support legs 156a, 156b may be in direct physical engagement with the ground, or an intervening support element such as a plate, a block and the like, can be disposed between the ends of the support legs 156a, 156b and the ground. In addition, the attachment 150 may be supported on the ground “on grade” (e.g. at ground level), “below grade” (e.g. for example in a trench where the ground support member(s) is engaged with side walls of the trench), or “above grade” (e.g. above ground level).

In use of the specific attachment 150 illustrated in FIGS. 6-7, with the attachment 150 attached to the arm 20 of the construction equipment 14 (see FIG. 1), the ends of the two pipes (see FIGS. 1-3) are picked up by the attachment 150 under the control of an operator in the cab 24 of the construction equipment 14 or by an operator on the ground using a portable control assembly. The ends of the two pipes are then aligned with one another using the attachment 150. In addition to aligning the ends of the pipes, the circumferential shapes of the pipe ends should generally match one another. So part of the alignment sequence can include a matching sequence, or a separate matching sequence can be initiated by the operator, to ensure the circumferential shapes of the pipe ends generally match. The matching sequence can be performed using sensors to determine the shapes of the pipe ends, and then suitably controlling the forces of the conforming rings 70, 72 to deform one or more of the pipe ends so they generally match one another.

In addition to alignment and achieving a general shape match, one or more of the ends of the pipe can be processed by the pipe processing tool on the attachment 150. Prior to processing, the ground support members 152 are actuated to extend the support legs 156a, 156b to the ground engagement position in order to support some or all of the weight of the attachment 150 on the ground. Once the attachment 150 is supported on the ground, one or more of the ends of the pipes can be processed using the pipe processing tool on the attachment 150. For example, in an embodiment where the pipe processing tool is a welding tool, the ends of the pipes can be welded to one another. Once the welding or other pipe processing is completed, the attachment 150 can then be used to lower the pipes, for example into a trench.

During the pipe processing, the attachment 150 may remain attached to the arm 20 of the construction equipment 14 or the attachment 150 may be disconnected from the arm 20 once the attachment 150 is supported by the ground support members 152 on the ground. Hydraulic and electric power for operating the attachment 150 may be provided from the construction equipment 14 and/or provided from a separate source(s) of hydraulic and electric power such as an electric generator and hydraulic system powered by the electric generator.

In the attachment 150 in FIGS. 6 and 7, when the support legs 156a, 156b are at the fully extended, ground engagement position, the end of each support leg 156a, 156b that include the ground engagement pads 162 are at a vertical position below the lowermost portion of the attachment 150, including lower than the grapple mechanism 42, the second grapple mechanism 44, and the deformation rings 70, 72 as best seen in FIG. 7. In contrast, as best seen in FIG. 6, in the retracted position of the support legs 156a, 156b, the ends of the support legs 156a, 156b including the ground engagement pads 162 may be approximately vertically level with the grapple mechanisms 42, 44 and the rings 70, 72 or raised to a vertical level vertically above a lowermost portion of the grapple mechanisms 42, 44 and the rings 70, 72.

In the end view of FIG. 7, the support legs 156a, 156b are each shown as having a longitudinal axis that is disposed at an angle to vertical. In other embodiments, the longitudinal axis of each support leg 156a, 156b can be vertical.

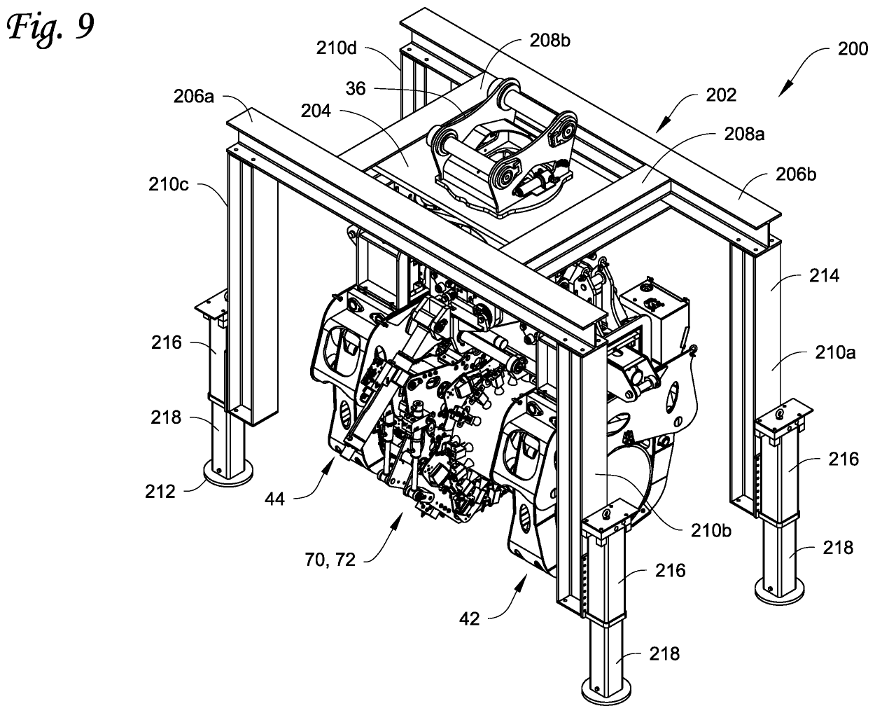

FIGS. 8 and 9 illustrate another embodiment of an attachment 200 having one or more ground support members 202 that are configured to directly support the attachment 200 on the ground. The ground support member 202 may also be referred to as ground stabilization mechanisms.

The attachment 200 can have a general construction that is similar to the grapple attachment 16 in FIGS. 1-5 except for the support member(s) 202. Accordingly, the attachment 200 may also be referred to as a grapple attachment. In FIGS. 8 and 9, elements that are similar to elements in FIGS. 1-5 and 6-7 are referenced using the same reference numerals. However, the attachment 200 is not limited to being a grapple attachment.

The attachment 200 is illustrated in FIGS. 8 and 9 as including the main beam, the first grapple mechanism 42 and the second grapple mechanism 44 mounted on the main beam, where the first grapple mechanism 42 and the second grapple mechanism 44 each includes opposing grab arms, and the system with the conforming rings 70, 72 (also referred to as a pipe conforming mechanism). Similar to the description above for the grapple attachment 16, a welding tool or other pipe processing tool, which can be similar to the tool 104, is mounted on one or more of the conforming rings 70, 72 for welding the pipes or performing another pipe processing operation on one or more of the pipes while the attachment 200 is holding the pipes.

In FIGS. 8 and 9, the ground support member 202 is illustrated as being a framework that is mounted to attachment 200 other than on the beam 30 as with the ground support members 152 in FIGS. 6 and 7. For example, FIGS. 8 and 9 illustrate the ground support ember 202 as being mounted on the attachment just below the attachment bracket 36. For example, the ground support member 202 can include a mounting plate 204 that mounts between the attachment bracket 36 and the lower head assembly 32. However, the ground support member 202 may be mounted to other structures on the attachment 200.

Many designs of the ground support member 202 are possible. In the illustrated example, the ground support member 202 is shown as including a pair of longitudinal support members 206a, 206b and a pair of cross-support members 208a, 208b. The support members 206a, 206b may extend parallel to the main beam 30 on opposite sides of the main beam 30 and on opposite sides of the attachment bracket 36. The cross-support members 208a, 208b extend between and are connected to the support members 206a, 206b on opposite sides of the attachment bracket 36, and the cross-support member 208a, 208b are also attached to the mounting plate 204. Support legs 210a, 210b, 201c, 201d are attached to the support members 206a, 206b. The support legs 210a-d are each individually actuatable, manually or using suitable actuators including, but not limited to, hydraulic, pneumatic or electric actuators, between a retracted position (FIG. 8) and an extended, ground-engaging position (FIG. 9) to support the attachment 200 on the ground. The end of each support leg 210a-d can include a ground engagement pad 212 each of which is pivotally attached to the end of the respective support leg 210a-d.

In FIGS. 8 and 9, each of the support legs 210a-d can be formed by a fixed member 214 that is fixed at an upper end thereof to the support members 206a, 206b. The fixed members 214 may be vertical and perpendicular to the support members 206a, 206b and perpendicular to the main beam 30. In other embodiments the fixed members 214 may extend at an angle to vertical. In addition, an actuatable jack mechanism 216 is mounted at the lower or opposite end of each fixed member 214. The actuatable jack mechanisms 216 form the extendable and retractable portions of the support legs 210a-d, with each jack mechanism 216 including an extendable leg 218 that can be manually actuated or actuated hydraulically, pneumatically or electrically.

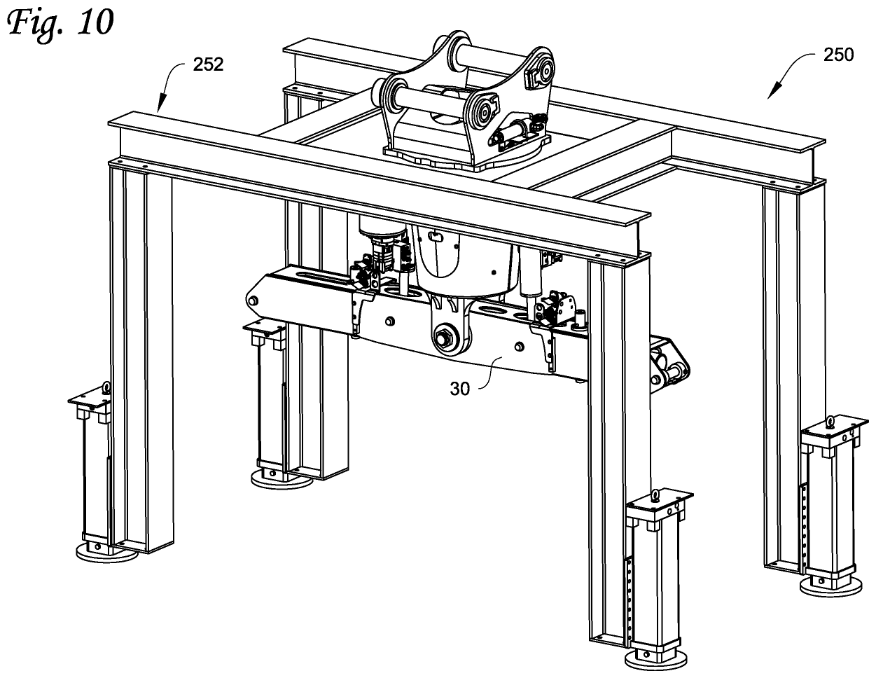

FIG. 10 illustrates another embodiment of an attachment 250 having a ground support member 252 that is similar to the ground support member 202 in FIGS. 8-9. The attachment 250 can have a general construction that is similar to the grapple attachment 16 in FIGS. 1-5 except for the support member(s) 252. Accordingly, the attachment 250 may also be referred to as a grapple attachment. In FIG. 10, elements that are similar to elements in FIGS. 1-9 are referenced using the same reference numerals. However, the attachment 250 is not limited to being a grapple attachment.

The attachment 250 illustrated in FIG. 10 is shown without any implements mounted on the beam 30. Accordingly, the attachment 250 (and any of the attachments described herein) can be supported by the ground support member on the ground with no jobsite performing implements on the main beam 30.

The ground support member(s) described herein may support the respective attachment on the ground, for example when the attachment is not in use performing a jobsite task. The attachment may or may not include a jobsite task implement mounted on the attachment when supported on the ground. For example, the attachment could include the main beam with no jobsite task performing implements on the main beam. In another embodiment, the support members described herein may support the respective attachment on the ground while the attachment is performing the jobsite task in which case the support provided by the ground support members does not interfere with the operation of the remainder of the attachment including the operation of any jobsite task implement mounted on the attachment.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An attachment that is mountable to an arm of construction equipment, comprising:
a mount bracket that is removably attachable to the arm of the construction equipment;
at least one ground support member mounted on the attachment, the at least one ground support member includes at least two support legs, and the support legs are actuatable between a retracted position and an extended, ground-engaging position at which the at least one ground support member supports the attachment on the ground.

2. The attachment of claim 1, further comprising an implement mounted to the mount bracket, the implement is configured to perform at least one jobsite task, and the implement is able to perform the at least one jobsite task when the at least one ground support member supports the attachment on the ground.

3. The attachment of claim 2, wherein the implement includes a main beam, and a first grapple mechanism and a second grapple mechanism mounted on the main beam; the first grapple mechanism and the second grapple mechanism each includes opposing grab arms; and
the at least one ground support member is mounted on the main beam.

4. The attachment of claim 3, wherein the implement further includes a pipe processing tool mounted on the grapple attachment and positioned between the first grapple mechanism and the second grapple mechanism.

5. The attachment of claim 4, wherein the implement further includes a pipe conforming mechanism positioned between the first grapple mechanism and the second grapple mechanism, and the pipe conforming mechanism includes first and second conforming rings.

6. The attachment of claim 5, wherein the pipe processing tool is mounted on the pipe conforming mechanism.

7. The attachment of claim 4 wherein the pipe processing tool comprises a pipe welding tool.

8. The attachment of claim 5, wherein the pipe conforming mechanism is mounted on the main beam.

9. The attachment of claim 3, comprising two of the ground support members mounted on the main beam, and the first grapple mechanism and the second grapple mechanism are positioned between the two ground support members.

10. The attachment of claim 9, wherein the first grapple mechanism is positioned between the second grapple mechanism and one of the two ground support members, and the second grapple mechanism is positioned between the first grapple mechanism and the other one of the two ground support members.

11. The attachment of claim 3, further comprising:
a lower head assembly rotatably connected to the mount bracket; and
the main beam is pivotally connected to the lower head assembly.

12. A method comprising:
mounting an attachment to an arm of construction equipment,
thereafter, with the attachment attached to the arm, actuating support legs on the attachment to an extended, ground engaging position in engagement with the ground so that the attachment is supported by the ground.

13. The method of claim 12, further comprising performing at least one jobsite task using an implement mounted on the attachment while the support legs support the attachment on the ground.

14. The method of claim 13, wherein performing the at least one jobsite task comprises using the implement to grab an end of a first pipe and grab an end of a second pipe, align the first pipe and the second pipe, and bring the end of the first pipe and the end of the second pipe adjacent to one another; and further comprising processing the end of the first pipe and/or processing the end of the second pipe using a pipe processing tool of the implement.

15. The method of claim 13, wherein the at least one jobsite task further comprises:
prior to processing, grabbing the end of the first pipe with a first conforming ring on the attachment, and grabbing the end of the second pipe with a second conforming ring on the attachment.

16. The method of claim 13, comprising performing the at least one jobsite task while the attachment is attached to the arm of the construction equipment.

17. The method of claim 13, comprising performing the at least one jobsite task while the attachment is detached from the arm of the construction equipment.

18. The method of claim 14, wherein the at least one jobsite task comprises welding.
